(19) United States
(12) Patent Application Publication
(10) Pub. No.: US 2016/0112472 A1
(43) Pub. Date: Apr. 21, 2016

(54) SYSTEM AND METHOD FOR MANAGING COMMUNICATION SESSIONS

(71) Applicant: Avaya Inc., Santa Clara, CA (US)

(72) Inventors: Jai Pugalia, San Jose, CA (US); Michael Krack, St. Pete Beach, FL (US); Wayne Wong, Milpitas, CA (US); Jeffrey Wong, San Jose, CA (US); Lee Shero, McKinney, TX (US)

(21) Appl. No.: 14/519,240

(22) Filed: Oct. 21, 2014

(51) Int. Cl. H04L 29/06; H04L 29/08

(52) U.S. Cl. CPC H04L 65/403; H04L 67/141

(57) ABSTRACT

A conference managing computer system for managing one or more communication sessions is disclosed. The conference managing computer system includes a monitoring module for monitoring one or more requests from one or more user devices to remotely access the communication session. The conference managing computer system further includes a detection module for detecting presence of the one or more user devices based on proximity. The conference managing computer system further includes a connection module for establishing one or more real time communication sessions with one or more detected user devices. The conference managing computer system further includes a conferencing module for managing the one or more communication sessions to enable the one or more detected user devices to join the communication session.

### BACKGROUND

1. Field

Embodiments of the present invention generally relate to a system and method to manage communication sessions within an enterprise and particularly to a system and method for managing communication sessions in real time.

2. Description of Related Art

Employees of an enterprise meet in a physical meeting room for an adhoc meeting session to share ideas and/or to discuss a topic. The meeting room can be, for example, a conference room, a lab, a workplace, and the like within the enterprise. However, it is difficult to manage the adhoc meeting sessions when one or more conferees leave the adhoc meeting session prior to its end.

Generally, these meeting sessions are mainly adhoc and/or unscheduled meetings and therefore no invites are sent to attendees of the meeting prior to the meeting session. Further, end time of the adhoc meeting sessions is also unknown. Often, one of the conferees may need to leave the adhoc meeting session prior to the end due to some reason, e.g., to meet a client, pick up daughter from school, etc. For this purpose, a communication device, such as, a telephone in the physical meeting room is used to call user devices associated with the conferees leaving the physical meeting room. One of the conferees in the physical meeting room manually dials a telephone number of a user device of the conferee, leaving the physical meeting room through the communication device present in the physical meeting room. However, these techniques require manual intervention and are also time-consuming. Also, the manual calling must be performed correctly otherwise the conferees of the conference session may be disconnected.

Further, if another attendee desires to leave the adhoc meeting, the process of establishing a manual call is repeated again. However, this may result in an interruption in the meeting session that further disrupts the flow of the meeting.

There is thus a need for a system and method for managing a real time communication session to enable remote conferees to join the communication session.

### SUMMARY

Embodiments in accordance with the present invention provide a conference managing computer system for managing one or more communication sessions. The conference managing computer system includes a monitoring module for monitoring one or more requests from one or more user devices to remotely access the communication session. The conference managing computer system further includes a detection module for detecting presence of the one or more user devices based on proximity. The conference managing computer system further includes a connection module for establishing one or more real time communication sessions with one or more detected user devices. The conference managing computer system further includes a conferencing module for managing the one or more communication sessions to enable the one or more detected user devices to join the communication session.

Embodiments in accordance with the present invention further provide a computer-implemented method for managing one or more communication sessions. The method includes monitoring one or more requests from one or more user devices to remotely access the communication session; detecting presence of the one or more user devices based on proximity; establishing one or more real time communication sessions with one or more detected user devices; and managing the one or more communication sessions to enable the one or more detected user devices to join the communication session.

Embodiments in accordance with the present invention further provide a computer-implemented method managing one or more communication sessions. The method includes monitoring one or more requests from one or more user devices to remotely access the communication session, wherein the one or more user devices are associated with one or more remote conferees; detecting presence of the one or more user devices based on proximity; establishing one or more real time communication sessions with one or more detected user devices; providing one or more web links associated with the one or more detected user devices to each other; and managing the one or more communication sessions to provide the remote access to the communication session from the one or more detected user devices.

Embodiments of the present invention may provide a number of advantages depending on its particular configuration. First, embodiments of the present application provide a system and a method for managing communication session in a real time environment. Embodiments of the present application monitors for a request to join a meeting session from a remote location. Further, embodiments of the present application detect presence of user devices that transmits the request based on proximity. Next, the system establishes a real time communication session with devices detected within the proximity.

Embodiments of the present application also create an adhoc communication session to enable conferees to break away from a meeting session and to continue to interact with other conferees of the meeting session via their mobile phones. Next, embodiments of the present application minimizes the interruption time of dialing a conferee's telephone number to create a conference call with the conferees. Next, embodiments of the present application eliminates manual intervention of dialing telephone numbers of conferees left the meeting session prior to its end. Further, embodiments of the present application also minimize the interruption in the flow of discussions in the physical meeting room.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a block diagram depicting a conference system, according to an embodiment of the present invention;

FIG. 2 illustrates components of a conferencing managing computer system, according to an embodiment of the present invention;

FIG. 3 illustrates an exemplary conference session scenario, according to an embodiment of the present invention;

FIG. 4 depicts a flowchart of a method for managing communication sessions, according to an embodiment of the present invention; and

FIG. 5 depicts a flowchart of a method for managing communication sessions, according to another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., a conference system. Although well suited for use with, e.g., a system having conference call capability or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “conferee” and variations thereof, as used herein, refers to a person who accessed/will access a conference system. The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a Private Branch Exchange (PBX), a conference system, an enterprise switch, or other type of communications system switch or server, as well as other types of processor-based communication control devices such as media servers, computers, adjuncts, etc.

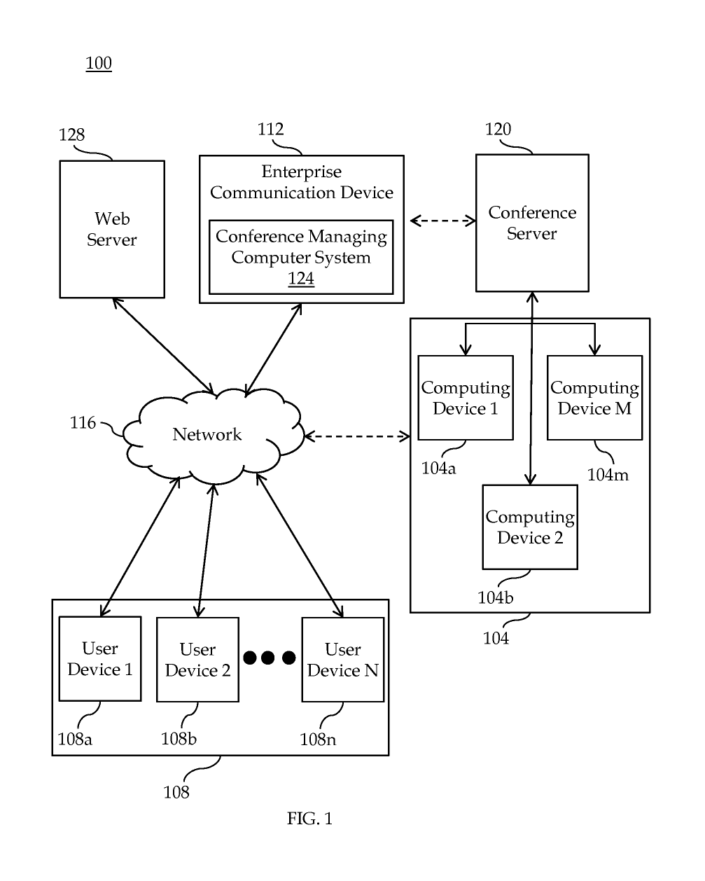

FIG. 1 illustrates an exemplary conferencing system 100 where various embodiments of the present invention may be implemented. As shown, the conferencing system 100 may include a physical meeting room 104 where conferees gather for a communication session. In an embodiment of the present invention, the communication session may be such as, but is not limited to, a conference session, a meeting session, and the like. In another embodiment of the present invention, the communication session may be, but is not limited to, an adhoc communication session. It will be appreciated by a person skilled in the art, a conference session is not limited to a telephony communication session and may also include a multimedia communication session, which may further include, but is not limited to, an audio session, a video session, a web session, a chatting session, and the like. The conferees of the communication session present in the physical meeting room 104 may use computing devices 104a-m for the communication session. In an embodiment of the present invention, the conferees of the communication session may be conferees situated in a location other than the physical meeting room 104. In an embodiment of the present invention, the computing devices 104a-m may include, but are not limited to, smartphones, desktop phones, Personal Computers (PCs), notebooks, cellular phones, Personal Digital Assistants (PDAs), tablets, wired or wireless communication devices, video conferencing hardware/software, or in general any communications devices that may be capable of sending and/or receiving communications. In an embodiment of the present invention, the computing devices 104a-m may be Web Real Time Communication (WebRTC) enabled computing devices.

The conferees present in the physical meeting room 104 may communicate with remote conferees 108 via an enterprise communication device 112. In an embodiment of the present invention, the remote conferees 108 may be conferees initially present in the physical meeting room 104 but left the physical meeting room 104 prior to the end of the meeting session. In an embodiment of the present invention, the enterprise communication device 112 may be a WebRTC enabled communication device such as, but is not limited to, a smartphone, a desktop phone, a Personal Computer (PC), a notebook, a Personal Digital Assistants (PDA), a cellular phone, a tablet, a wired or wireless communication device, a video conferencing hardware/software, or in general any communication device that may be capable of sending and/or receiving communications. The enterprise communication device 112 may be installed in the physical meeting room 104, in an embodiment of the present invention. The enterprise communication device 112 may be a meeting room phone within the physical meeting room 104, in an embodiment of the present invention. In another embodiment of the present invention, the enterprise communication device 112 may be a user device, such as, the user device 108.

The computing devices 104a-m may communicate with user devices 108a-n of the remote conferees 108 through the enterprise communication device 112 via one or more network(s) 116. In an embodiment of the present invention, the user devices 108a-n may be WebRTC enabled user devices. In another embodiment of the present invention, each of the computing devices 104a-n, user devices 108a-n, and/or enterprise communication device 112 within the conferencing system 100 may establish a WebRTC communication session with each other. The network(s) 116 may be packet-switched and/or circuit-switched. Examples of the network(s) 116 may include, but are not limited to, Local Area Network (LAN), Wide Area Network (WAN), the Internet, Public Switched Telephone Network (PSTN), a Plain Old Telephone Service (POTS) network, a cellular communications network, or combinations thereof. In addition, the computing devices 104a-n may include devices capable of communicating over the network(s) 116 by using protocols such as, but are not limited to, Transmission Control Protocol (TCP), Internet Group Management Protocol (IGMP), Internet Control Message Protocol (ICMP), and the like. The conferencing system 100 may further include a conference server 120 to provide conferencing services to the conferees present in the physical meeting room 104 to communicate with the remote conferees 108.

Further, the enterprise communication device 112 may include, but is not limited to, a conference managing computer system 124, in an embodiment of the present invention. In another embodiment of the present invention, the conference managing computer system 124 may be an independent device connected to the enterprise communication device 112. The conference managing computer system 124 may monitor one or more requests from conferees initially present in the physical meeting room 104 to remotely join and/or access a meeting session. In an embodiment of the present invention, the adhoc meeting session may be, but is not limited to, an ongoing meeting session. The meeting session may be a meeting session that may be scheduled in near future, for example, in 10 minutes, 25 minutes, etc., in another embodiment of the present invention.

Further, the conference managing computer system 124 may detect user devices 108a-n that transmits the request to remotely join and/or access the meeting session. In an embodiment of the present invention, the user devices 108a-n may be detected based on proximity to the enterprise communication device 112. The conference managing computer system 124 may also establish a communication session with the remote conferees 108. In an embodiment of the present invention, the communication session may be a real time communication session. The conference managing computer system 124 may further initiate the communication session to enable the remote conferees 108 to join the meeting session from remote locations.

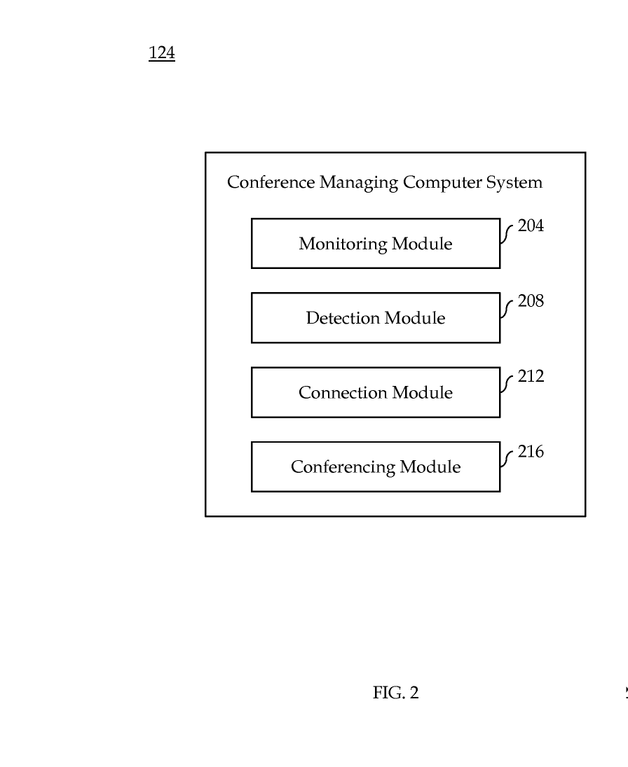

The conference managing computer system 124 may provide a web link to the user devices 108a-n of the remote conferees to establish the communication session with the conference managing computer system 124. In an embodiment of the present invention, the web link may be provided by a web server 128. In an embodiment of the present invention, the web server 128 may provide different web links to each of the user devices 108a-n to differentiate between the remote conferees 108. Further, the conference managing computer system 124 may provide the web links associated with the user devices 108a-n of the remote conferees 108 to each other for initiating the communication session. The components of the conference managing computer system 124 are described in conjunction with FIG. 2.

FIG. 2 is a diagram of components of the conference managing computer system 124 for managing a communication session, according to an embodiment of the present invention. The conference managing computer system 124 includes certain modules, such as, but is not restricted to, a monitoring module 204, a detection module 208, a connection module 212, and a conferencing module 216. In some embodiments of the present invention, one or more of the monitoring module 204, the detection module 208, the connection module 212, and the conferencing module 216 may be implemented by one or more software processes running on the web server 128, the conference server 120, or a combination thereof. The web server 128, the conference server 120, or a combination thereof may implement one or more software processes by use of a processor (not shown) being suitably programmed by use of software instructions stored in a memory (not shown) coupled to the processor.

The monitoring module 204 may monitor for a request to remotely access a meeting session from a user device. In an embodiment of the present invention, when a conferee of a meeting session present in a physical meeting room opens a web browser in an associated user device then the monitoring module 204 may monitor that the conferee desires to join the meeting session from a remote location. In another embodiment of the present invention, more than one conferee of the meeting session may also desire to join the meeting session from different remote locations.

Further, the monitoring module 204 may receive a request from the conferee in the physical meeting room 104 to remotely join and/or access the meeting session. When the conferee desires to leave the meeting session prior to its end then the conferee transmits a request to remotely access the meeting session. The conferee of the meeting session may open a web browser in a user device to transmit the request, in an embodiment of the present invention. In another embodiment of the present invention, the conferee may click on a web link displayed in the web browser to transmit a request to the web server 128 to remotely join the meeting session. In an embodiment of the present invention, the web link may be such as, but is not limited to, a bookmarked web link. The web link may be, for example, but is not limited to, a Uniform Resource Locator (URL), in an embodiment of the present invention. The request may indicate that the conferee desires to leave the physical meeting room 104 and to join the meeting session from a remote location, in an embodiment of the present invention.

The monitoring module 204 may provide a web link to the user device associated with the conferee who desires to leave the physical meeting room. In an embodiment of the present invention, the web link may include, but is not limited to, a WebRTC connection URL. Further, based on the received request, a WebRTC connection URL is provided to the user device of the conferee to join the meeting session from a remote location. The WebRTC connection URL may be provided by the web server 128, in an embodiment of the present invention. The WebRTC connection URL provided to the conferee is unique to, but is not limited to, a user device, a conferee and/or an identification of a conferee, or a combination thereof. In an exemplary embodiment of the present invention, if a second conferee also desires to leave the meeting session then a second WebRTC connection URL, different than the first WebRTC connection URL, is provided to the second conferee.

The detection module 208 may detect the presence of the user device through which the request is received. In an embodiment of the present invention, the user device may be detected based on proximity. The proximity of the user device may be detected from the enterprise communication device 112, in an embodiment of the present invention. The detection module 208 may detect the presence of the user device based on its interaction with the enterprise communication device 112, in another embodiment of the present invention. The proximity of the user device may be detected by the detection module 208 when the conferee taps, for example, but is not limited to, a touch, the user device on the enterprise communication device 112, in an exemplary embodiment of the present invention. For example, the detection module 208 detects proximity of a user device of a conferee who desires to leave the meeting session when the conferee taps the user device on the enterprise communication device 112.

In another embodiment of the present invention, the detection module 208 may detect the proximity of the user device based on Near Field Communication (NFC). The enterprise communication device 112 may include, but is not limited to, a NFC card reader that may read and/or detect presence of the user device within the proximity. The NFC range of the user device from the enterprise communication device 112 may be, but is not limited to, not more than an inch, for example, 1 centimeter, 1.25 centimeters, 0.5 centimeters, etc. In another embodiment of the present invention, a Bluetooth™, proximity detecting techniques, or a combination thereof, may also be used to detect presence of the user device within the proximity.

The detection module 208 may further receive the web link provided to the user device by the web server 128. In an embodiment of the present invention, the web link may be the WebRTC connection URL provided to the user device by the web server 128. In an embodiment of the present invention, the web link, e.g., WebRTC connection URL may be automatically transmitted to the detection module 208 based on the proximity of the user device with the enterprise communication device 112.

Further, the detection module 208 may determine a delay parameter. In an embodiment of the present invention, the delay parameter may be included in the WebRTC connection URL. The delay parameter may include, but is not limited to, an instruction (e.g., call me after ten minutes) that may instruct the enterprise communication device 112 to wait for a particular time interval, for example, five minutes, 12 minutes, etc. before attempting to establish a communication session between the user device and the enterprise communication device 112. In an embodiment of the present invention, the delay parameter may include, such as, but is not restricted to, a delay time to establish a communication session for an ongoing adhoc meeting session. In another embodiment of the present invention, the delay parameter may include a delay time for a meeting session that may start after a short duration of time, for example, within ten minutes. In an exemplary embodiment of the present invention, the delay parameter may indicate that the conferee leaving the physical meeting room may not desire to immediately start the communication session. For example, a conferee may plan to make another important call and then start the communication session, or another conferee may desire to start the communication session after getting into a car, and so on.

The connection module 212 may establish a real time communication connection with the user devices. In an embodiment of the present invention, the real time communication connection may be such as, but is not limited to, a WebRTC communication connection. In an embodiment of the present invention, the connection module 212 may establish the real time communication connection with the user devices detected within the proximity. For example, if three user devices transmit requests to establish real time communication connections with the enterprise communication device 112, and only two user devices are detected to be within the proximity then two separate real time communication connections (one with each user device) of the detected user devices are established.

The conferencing module 216 may manage the communication session to enable the detected user device to remotely join the meeting session. In an embodiment of the present invention, the conferencing module 216 may initiate the communication session to enable the detected user device to remotely join the meeting session. The conferee may then be able to be a part of the meeting session from a remote location and may further be able to listen and/or see an event going on in the meeting session.

Further, the conferencing module 216 may provide the web link, i.e., WebRTC connection URL, to other conferees of the meeting session. In an embodiment of the present invention, other conferees may be, but is not limited to, remote conferees 108 that are a part of the meeting from remote locations. The conferencing module 216 may provide WebRTC connection URLs associated with each user device to other user devices that are part of the meeting session from remote locations so that there browsers mix in the audio from all the user devices.

For example, if a first conferee is remotely accessing a meeting session and a second conferee leaves the physical meeting room then a WebRTC connection URL associated with the second conferee is provided to the first conferee to communicate with each other.

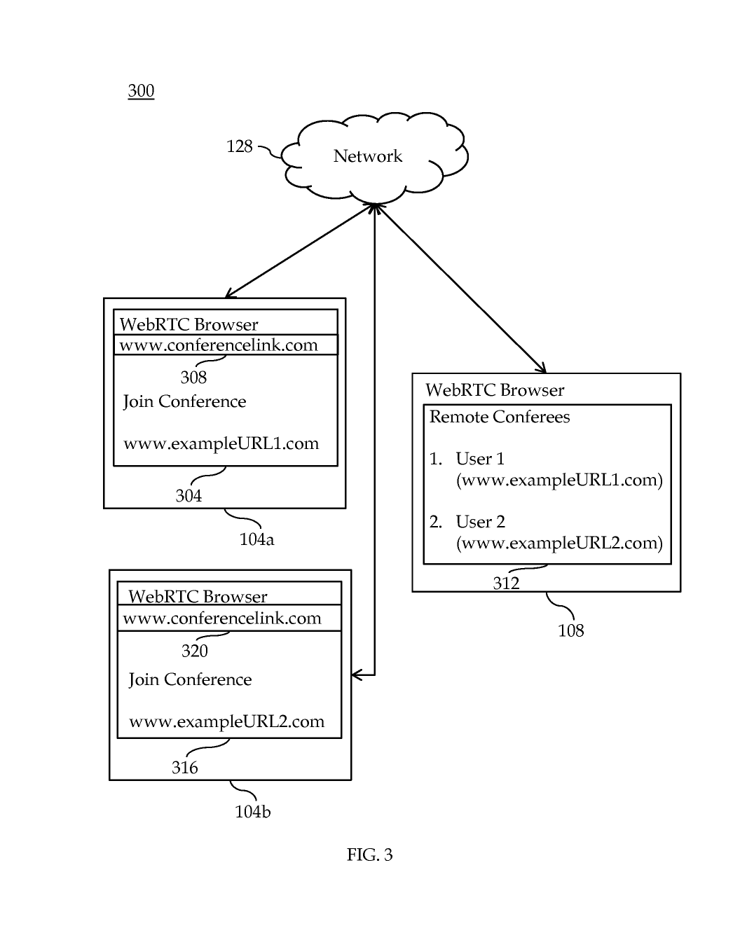

FIG. 3 illustrates an exemplary architecture in which various embodiments may be implemented, according to an embodiment of the present invention. An adhoc meeting session is taking place in the physical meeting room 104. One of a conferee desires to leave the adhoc meeting session prior to the end of the adhoc meeting session due to some reason, for example, for a meeting, pick up daughter from school, etc. but to join the adhoc meeting session from a remote location. For this purpose, the conferee opens a WebRTC browser 304 on a computing device 104a. A web link 308 (e.g., www.conferencelink.com) bookmarked on the computing device 104a is clicked by the conferee and a web page is displayed. The web page displays a WebRTC communication URL (e.g., www.exampleURL1.com) that is unique to the conferee, the computing device 104a, or a combination thereof. When the conferee taps the computing device 104a on the enterprise communication device 112 in the physical meeting room 104, the WebRTC communication URL is transmitted to the enterprise communication device 112. A real time communication session is then established with the computing device 104a. The WebRTC communication URL associated with the computing device 104a is then displayed 312 on user devices of remote conferees 108 to communicate with the conferee.

Similarly, when a second conferee desires to leave the adhoc meeting session prior to the end but to remotely join the adhoc meeting session, the second conferee also opens a WebRTC browser 316 on a second computing device 104b. A web link 320 (e.g., www.conferencelink.com) bookmarked on the second computing device 104b is clicked by the second conferee and a web page is displayed on the second computing device 104b. The web page displays a web link, such as, a WebRTC communication URL (e.g., www.exampleURL2.com) unique for the second conferee, the computing device 104b, or a combination thereof. When the second conferee taps the computing device 104b on the enterprise communication device 112 installed in the physical meeting room 104, the WebRTC communication URL is transmitted to the enterprise communication device 112. A real time communication session is then established with the computing device 104b. The WebRTC communication URL associated with the second computing device 104b is then displayed in the list of remote conferees 312 on user devices of remote conferees 108 to communicate with the second conferee. The conferees may then be able to communicate with each other as well as with conferees present in the physical meeting room 104 via the network(s) 116.

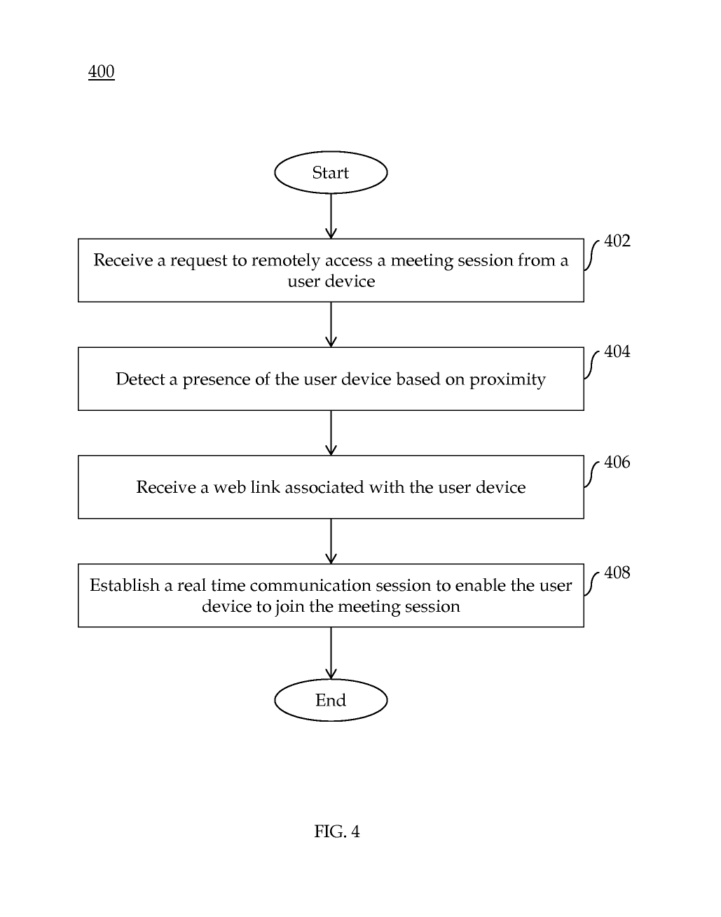

FIG. 4 depicts a flowchart of a method 400 for managing communication sessions, according to an embodiment of the present invention.

At step 402, a conference managing computer system 124 receives a request to remotely access a meeting session from a user device. In an embodiment of the present invention, the conference managing computer system 124 receives a request from a conferee present in a physical meeting room 104 to remotely access the meeting session going on in the physical meeting room 104. The conferee may transmit a request to remotely access the meeting session when the conferee desires to leave prior to the end of the meeting session. To transmit the request, the conferee of the meeting session may open a web browser in a user device associated with the conferee, in an embodiment of the present invention. The conferee may then click on a web link displayed in the web browser to transmit a request to the web server 128 to remotely access the meeting session. When the web browser is opened by the conferee, it indicates that the conferee desires to leave the physical meeting room and then join the meeting session from a remote location.

At step 404, the conference managing computer system 124 detects presence of the user device based on proximity. The conference managing computer system 124 detects the presence of the user device through which the request is received. The proximity of the user device may be detected from the enterprise communication device 112, in an embodiment of the present invention. The conference managing computer system 124 detects the presence of the user device based on its interaction with the enterprise communication device 112, in another embodiment of the present invention. The proximity of the user device may be detected when the conferee taps, for example, touches, the user device on the enterprise communication device 112, in an exemplary embodiment of the present invention.

In another embodiment of the present invention, the conference managing computer system 124 detects the proximity of the user device based on Near Field Communication (NFC). The enterprise communication device 112 may include, but is not limited to, a NFC card reader that may read and/or detect presence of the user device within the proximity. The NFC range of the user device from the enterprise communication device 112 may be, but is not limited to, not more than an inch, for example, 1 centimeter, 1.25 centimeters, 0.5 centimeters, etc. In another embodiment of the present invention, a Bluetooth™, proximity detecting techniques, or a combination thereof, may also be used to detect presence of the user device within the proximity.

Next, at step 406, the conference managing computer system 124 receives a web link provided to the user device by the web server 128. In an embodiment of the present invention, the web link may be such as, but is not limited to, a WebRTC connection URL provided to the user device. In an embodiment of the present invention, the web link may be automatically transmitted to the conference managing computer system 124 based on the proximity of the user device with the enterprise communication device 112.

Thereafter, at step 408, the conference managing computer system 124 establishes a real time communication connection with the user device. In an embodiment of the present invention, the real time communication connection may be such as, but is not limited to, a WebRTC communication connection. In an embodiment of the present invention, the conference managing computer system 124 establishes the real time communication connection with the user device detected within the proximity. For example, if four user devices transmit requests to establish real time communication connections with the enterprise communication device 112, and only one user device is detected to be within the proximity then a real time communication connection is established with the detected user device only. The conferee then joins the meeting session from a remote location.

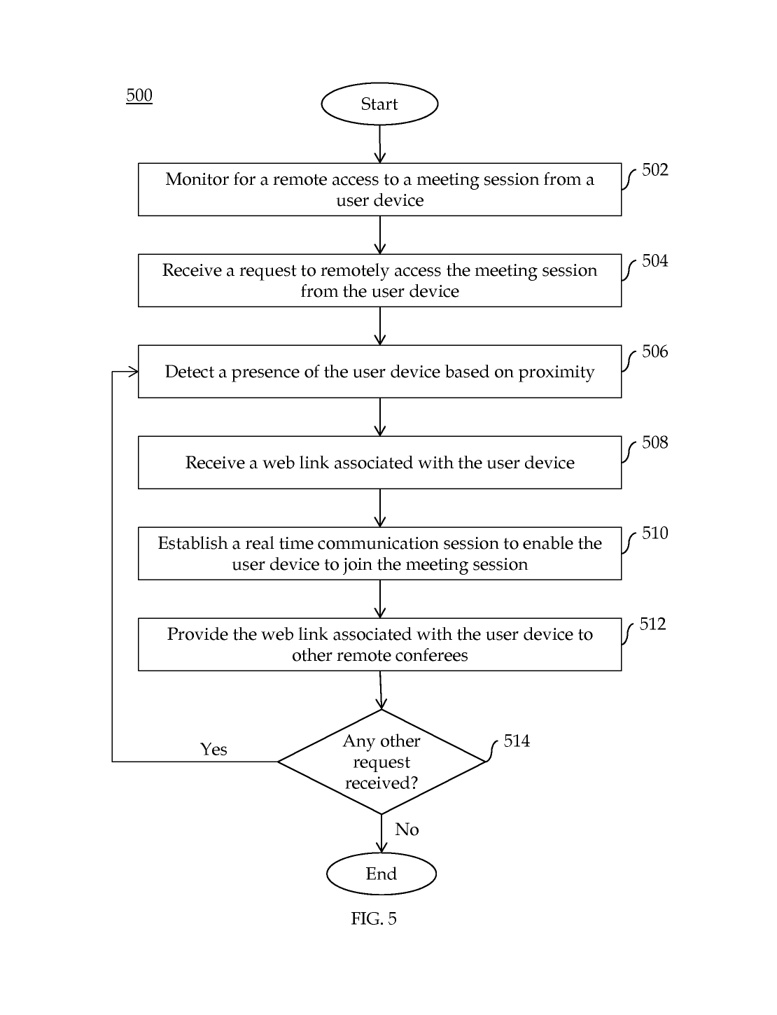

FIG. 5 depicts a flowchart of a method 500 for managing communication sessions, according to another embodiment of the present invention.

At step 502, a conference managing computer system 124 monitors for a remote access to a meeting session from a user device. In an embodiment of the present invention, when a conferee of a meeting session present in a physical meeting room opens a web browser in an associated user device then the conference managing computer system 124 monitors that the conferee desires to access and/or join the meeting session from a remote location. In another embodiment of the present invention, more than one conferee of the meeting session may also desire to join the meeting session from different remote locations.

At step 504, the conference managing computer system 124 receives a request to remotely access a meeting session from a user device. In an embodiment of the present invention, the conference managing computer system 124 receives a request from a conferee in a physical meeting room to remotely join and/or access a meeting session going on in the physical meeting room. The conferee transmits a request to remotely access the meeting session when the conferee desires to leave in the middle of the meeting session in the physical meeting room. To transmit the request, the conferee of the meeting session opens a web browser in an associated user device, in an embodiment of the present invention. The conferee then clicks on a web link displayed in the web browser to transmit a request to the web server 128 to remotely access the meeting session.

Next, at step 506, the conference managing computer system 124 detects presence of the user device based on proximity. The conference managing computer system 124 detects the presence of the user device through which the request is received. The proximity of the user device may be detected from the enterprise communication device 112, in an embodiment of the present invention. The conference managing computer system 124 detects the presence of the user device based on its interaction with the enterprise communication device 112, in another embodiment of the present invention. The proximity of the user device may be detected when the conferee taps, for example, touches, the user device on the enterprise communication device 112, in an embodiment of the present invention.

In another embodiment of the present invention, the conference managing computer system 124 detects the proximity of the user device by using Near Field Communication (NFC). The enterprise communication device 112 may include, but is not limited to, a NFC card reader that may read and/or detect presence of the user device within the proximity. The NFC range of the user device from the enterprise communication device 112 may be, but is not limited to, not more than an inch, for example, 1 centimeter, 1.25 centimeters, 0.5 centimeters, etc. In another embodiment of the present invention, a Bluetooth™, proximity detecting techniques, or a combination thereof, may also be used to detect presence of the user device within the proximity.

Next, at step 508, the conference managing computer system 124 receives a web link provided to the user device by the web server 128. In an embodiment of the present invention, the web link may be such as, but is not limited to, a WebRTC connection URL provided to the user device. In an embodiment of the present invention, the web link may be automatically transmitted to the conference managing computer system 124 based on the proximity of the user device with the enterprise communication device 112.

Thereafter, at step 510, the conference managing computer system 124 establishes a real time communication connection with the user device. In an embodiment of the present invention, the real time communication connection may be such as, but is not limited to, a WebRTC communication connection. In an embodiment of the present invention, the conference managing computer system 124 establishes the real time communication connection with the user device detected within the proximity. For example, if two user devices transmit requests to establish real time communication connections with the enterprise communication device 112, and only one user device is detected to be within the proximity then a real time communication connection is established only with the detected user device. The conferee then joins the meeting session from a remote location.

Further, at step 512, the conference managing computer system 124 provides the web link associated with the user device to other remote conferees. In an embodiment of the present invention, other conferees may be, but is not limited to, remote conferees 108 that are a part of the meeting from remote locations. The conference managing computer system 124 provides the web link to other user devices that are part of the meeting session from remote locations so that there browsers mix in the audio from all the user devices. For example, if a first conferee is remotely accessing a meeting session and a second conferee joins the communication session from a remote location then a WebRTC connection URL associated with the second conferee's user device is provided to the first conferee to communicate with each other.

At step 514, the conference managing computer system 124 determines whether any other request is received from another user device. If it is determined that a request is received to remotely access the meeting session from a second user device then the process 500 returns to the step 506 and continue detecting presence of the second user device. Otherwise, the process 500 concludes.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A conference managing computer system for managing one or more communication sessions, the system comprising:
a monitoring module for monitoring one or more requests from one or more user devices to remotely access the communication session;
a detection module for detecting presence of the one or more user devices based on proximity;
a connection module for establishing one or more real time communication sessions with one or more detected user devices; and
a conferencing module for managing the one or more communication sessions to enable the one or more detected user devices to join the communication session.

2. The system of claim 1, wherein the monitoring module is further configured to receive the one or more request from the one or more user devices to remotely access the communication session.

3. The system of claim 1, wherein the one or more user devices are Web Real Time Communication (Web RTC) enabled user devices.

4. The system of claim 1, wherein the monitoring module is further configured to provide one or more web links to the one or more user devices.

5. The system of claim 4, wherein the one or more web links are unique based on a user device, a conferee of the communication session, or a combination thereof.

6. The system of claim 1, wherein the presence of the one or more user devices is detected based on at least one interaction with an enterprise communication device.

7. The system of claim 1, wherein the presence of the one or more user devices is detected based on Near Field Communication (NFC) of the one or more user devices within the proximity of a NFC card reader.

8. The system of claim 1, wherein the detection module is further configured to determine at least one delay parameter from the one or more requests.

9. The system of claim 8, wherein the delay parameter comprises at least one instruction to wait for a time interval before attempting to establish the one or more real time communication sessions with the one or more detected user devices.

10. The system of claim 1, wherein the one or more real time communication sessions are WebRTC communication sessions.

11. The system of claim 1, wherein the conferencing module is further configured to provide the one or more web links associated with the one or more detected user devices to each other.

12. A computer-implemented method for managing one or more communication sessions, the method comprising:
monitoring one or more requests from one or more user devices to remotely access the communication session;
detecting presence of the one or more user devices based on proximity;
establishing one or more real time communication sessions with one or more detected user devices; and
managing the one or more communication sessions to enable the one or more detected user devices to join the communication session.

13. The method of claim 12, further comprising receiving the one or more request from the one or more user devices to remotely access the communication session.

14. The method of claim 12, further comprising providing one or more web links to the one or more user devices.

15. The method of claim 12, wherein the presence of the one or more user devices is detected based on Near Field Communication (NFC) of the one or more user devices within the proximity of a NFC card reader.

16. The method of claim 12, further comprising determining at least one delay parameter from the one or more requests.

17. The method of claim 12, further comprising providing the one or more web links associated with the one or more detected user devices to each other.

18. A computer-implemented method for managing one or more communication sessions, the method comprising:
monitoring one or more requests from one or more user devices to remotely access the communication session, wherein the one or more user devices are associated with one or more remote conferees;
detecting presence of the one or more user devices based on proximity;
establishing one or more real time communication sessions with one or more detected user devices;
providing one or more web links associated with the one or more detected user devices to each other; and
managing the one or more communication sessions to provide the remote access to the communication session from the one or more detected user devices.

19. The method of claim 18, wherein the presence of the one or more user devices is detected based on Near Field Communication (NFC) of the one or more user devices within the proximity of a NFC card reader.

20. The method of claim 18, further comprising determining at least one delay parameter from the one or more requests.
